(19) United States
(12) Patent Application Publication
(10) Pub. No.: US 2018/0070691 A1
(43) Pub. Date: Mar. 15, 2018

(54) RIGID INTERCHANGEABLE TOOL POUCH INSERT

(71) Applicant: Jordan Franks, Lehi, UT (US)

(72) Inventor: Jordan Franks, Lehi, UT (US)

(21) Appl. No.: 15/264,510

(22) Filed: Sep. 13, 2016

(51) Int. Cl. A45C 13/02; B25H 3/00

(52) U.S. Cl. CPC A45C 13/02; A45C 2013/026; B25H 3/00

(57) ABSTRACT

An interchangeable rigid insert for protecting a flexible pocket is provided. The rigid insert comprises one or more sidewalls, a base, a forward panel, and a rearward panel. The insert may comprise an upwardly-rising back portion and may be adjustable in width. The base may be thicker than the sidewalls and forward panel.

### BACKGROUND OF THE INVENTION

### Field of the Invention

This invention relates to a liner for protecting pockets, and more particularly relates to a rigid pocket insert for preventing damage to the pocket from sharp construction implements.

### Description of the Related Art

Sharp construction implements are often stored in portable tool bags in confined spaces within a flexible leather or polymeric pocket. Although the materials forming the pocket can withstand great tensile force, the pockets are not resistant to damage from abrasion, cutting, gashing and impact with the sharp edges of construction implements, such as razors, screwdrivers, drill bits, hammers, and the like. The movements of the implements within the pockets during transport, and as a user goes about his day-to-day labor, exacerbate the back-and-forth wear between the pocket's flexible material and the construction implements. The flexible material forming the pocket is used by tool bag manufacturers because it can be sewn, stitched or adhered more efficiently to a larger flexible body forming the central compartment of the tool bag. This inefficiency in the art results in flexible pockets of tool bags quickly developing holes on the lower surfaces of the pocket through which even blunt implements fall and are lost.

The present invention is directed to systems, apparatuses and methods for protecting flexible pockets from damage by sharp construction implements, and cures a deficiency in the art. Although the prior art teaches protecting the pockets of clothing from ink, none are directed to protection of tool bags from construction implements and sharp surfaces. The actual utility and functionality of the devices taught in the prior art is limited.

There exists a need in the industry for a means of protecting flexible tool bag from sharp construction implements which remains unmet. It is desirable that this device be interchangeable with a variety of pockets, while also being interchangeable with other easily storable, simple and inexpensive. It is the object of the present invention to provide such an apparatus and means which meets these needs.

### SUMMARY OF THE INVENTION

From the foregoing discussion, it should be apparent that a need exists for an rigid tool pouch liner. The present invention has been developed in response to the present state of the art; and, in particular, in response to the problems and needs in the art that have not yet been fully solved by currently available methods, systems and apparati, and that overcome many or all of the above-discussed shortcomings in the art. Accordingly, the present invention has been developed to provide rigid tool pouch liner, the tool pouch liner comprising: a rearward panel having a planar interior surface and a planar exterior surface; two sidewalls affixed to the rearward panel, the sidewalls disposed laterally to the rearward panel; a forward panel affixed to the sidewalls, the forward panel having a planar interior surface and a planar exterior surface; a base disposed beneath the sidewalls, the rearward panel, and the forward panel, the base affixed to the sidewalls, the rearward panel, and the forward panel; an upwardly protruding back affixed to the rearward panel and the sidewalls, the upwardly protruding panel rising more than 10 mm above the forward panel; wherein the rigid pouch liner forms a cubic housing with an open top end.

The rigid pouch liner may be formed as a single integrated piece. The tool pouch liner may be adhered to a pouch of a tool bag using adhesive. The base may comprise thicker polymeric material than the forward panel, rearward panel, or sidewalls.

A second adjustable-width tool pouch liner, the tool pouch liner comprising: an outward housing comprising: a rearward panel having a planar interior surface and a planar exterior surface; a sidewalls affixed to the rearward panel, the sidewall disposed laterally to the rearward panel; a forward panel affixed to the sidewall, the forward panel having a planar interior surface and a planar exterior surface; a base disposed beneath the sidewall, the rearward panel, and the forward panel, the base affixed to the sidewalls, the rearward panel, and the forward panel; wherein the outward housing forms a cubic housing with an open top end and an open lateral end, the outward housing for receiving slidably an inward housing; an inward housing comprising: a rearward panel having a planar interior surface and a planar exterior surface; a sidewalls affixed to the rearward panel, the sidewall disposed laterally to the rearward panel; a forward panel affixed to the sidewall, the forward panel having a planar interior surface and a planar exterior surface; a base disposed beneath the sidewall, the rearward panel, and the forward panel, the base affixed to the sidewalls, the rearward panel, and the forward panel; wherein the inward housing forms a cubic housing with an open top end and an open lateral end, the inward housing for partially inserting slidably into the outward ward housing.

A rigid tool pouch liner is also provided, the tool pouch liner comprising: a polymeric rearward panel having a planar interior surface and a planar exterior surface; two polymeric sidewalls affixed to the rearward panel, the sidewalls disposed laterally to the rearward panel; a polymeric forward panel affixed to the sidewalls, the forward panel having a planar interior surface and a planar exterior surface; a metal base disposed beneath the sidewalls, the rearward panel, and the forward panel, the base affixed to the sidewalls, the rearward panel, and the forward panel; wherein the rigid pouch liner forms a cubic housing with an open top end.

The base may comprise thicker polymeric material than the forward panel, rearward panel, or sidewalls. The rigid pouch liner may be formed as part of a larger tool bag.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an upper elevational environmental perspective view of a rigid interchangeable tool pouch insert in accordance with the present invention;

FIG. 2A is a forward, upper elevational environmental perspective view of a rigid interchangeable tool pouch insert in accordance with the present invention;

FIG. 2B is a sectioned side perspective view of a rigid interchangeable tool pouch insert in accordance with the present invention;

FIG. 3 is a side perspective view of a rigid interchangeable tool pouch insert in accordance with the present invention;

FIG. 4 is a forward-side perspective view of a rigid interchangeable tool pouch insert in accordance with the present invention;

FIG. 5 is a forward-side perspective view of a rigid interchangeable, adjustable tool pouch insert in accordance with the present invention.

FIG. 6 is a forward-side perspective view of the outward lateral housing of a rigid interchangeable, adjustable tool pouch insert in accordance with the present invention; and

FIG. 7 is a forward-side perspective view of the inward lateral housing of a rigid interchangeable, adjustable tool pouch insert in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The provision of a device for lining and protecting a pouch in a tool bag from cutting by sharp implements is an object of the present invention.

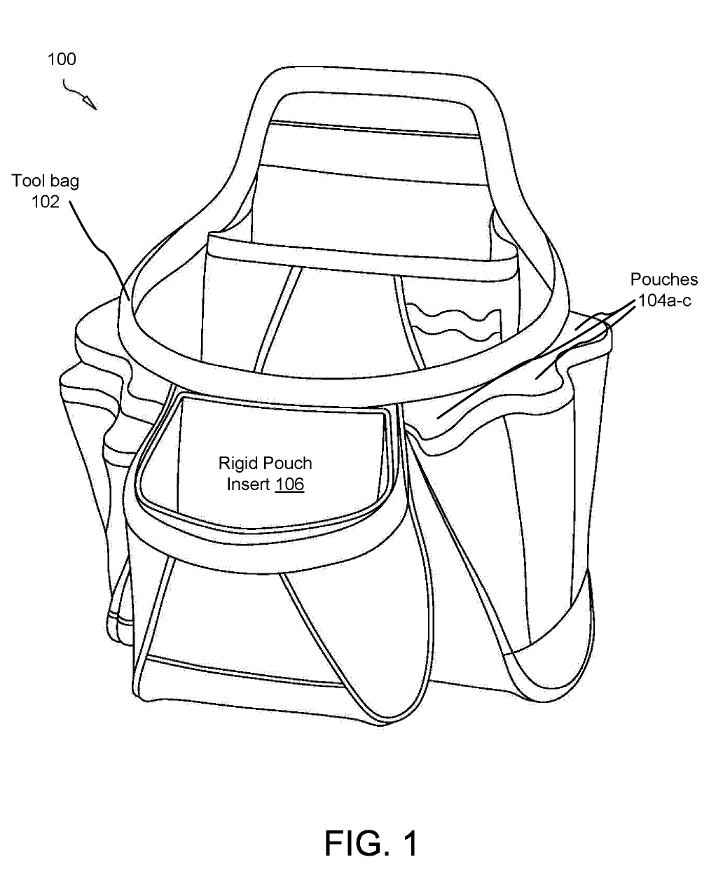

FIG. 1 is an upper elevational environmental perspective view of a rigid interchangeable tool pouch insert 100 in accordance with the present invention.

The insert 100 is preferably formed of a resinous material or metal alloy, but may be formed of an organic material such as leather or wood.

The insert 100 has a forward panel, a rearward panel, two sidewalls disposed laterally to the sides, and a lower surface or base. These components may be fabricated separately and welded or otherwise affixed together or the insert 100 may be formed as a single integrated piece.

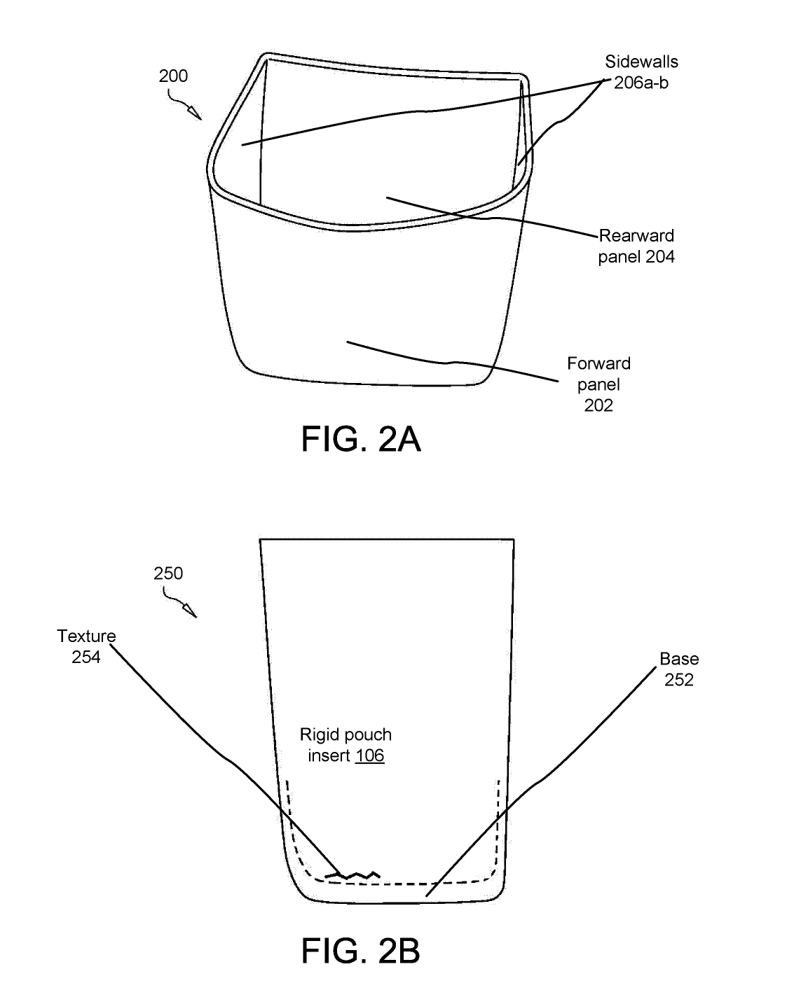

FIG. 2A is a forward, upper elevational environmental perspective view of a rigid interchangeable tool pouch insert 200 in accordance with the present invention.

The insert 100 may comprise a box-shaped housing having an open top end as shown. In various embodiments, the sidewalls 206 are convex and curve traversing forward to meet the forward panel 202 while being affixed at a right angle to the rearward panel 204.

FIG. 2B is a sectioned side perspective view of a rigid interchangeable tool pouch insert 250 in accordance with the present invention.

The base 252 comprises the lower surface of the insert 250. The base 252, in some embodiments, is formed for a differing material than the rearward panel 204, the sidewalls 206, and the forward panel 202. The base 252 may be adapted to withstand higher force of impact from implements than the remaining components of the insert 250. The base 250 may be formed from higher durometer polymerics and/or thicker and/or denser polymerics. In other variations, while the sidewalls 206, rearward panel 204, and forward panel 202 are formed as a single integrated piece from elastomeric materials, the base 252 may be formed from metal or metal alloy materials to increase the base's 252 resistance to contact with sharp surfaces.

The base 252 as shown is thicker than the sidewalls 206, rearward panel 204, or forward panel 202.

The base 252 may also comprise, as shown, a textured interior top surface 254. This textured surface 254 is adapted to help prevent implements/tools held within the insert 250 from slipping to one side of the underlying pocket.

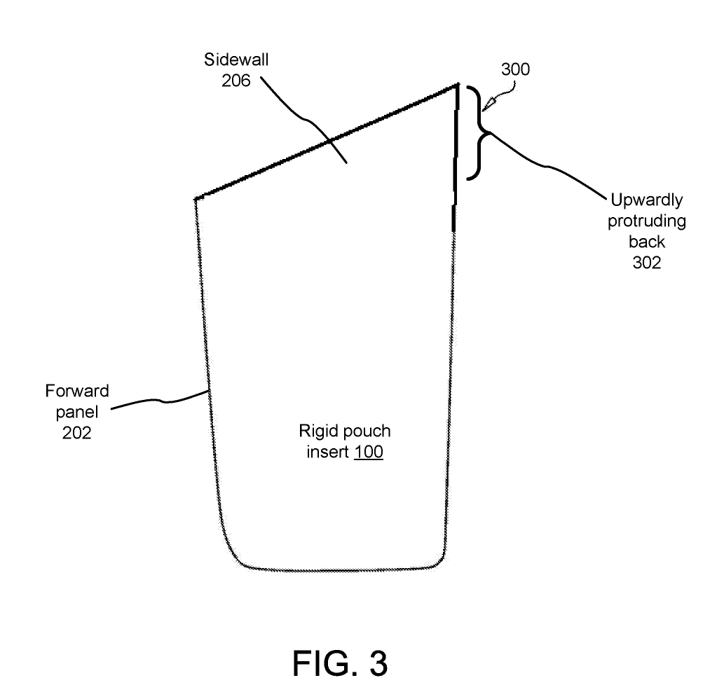

FIG. 3 is a side perspective view of a rigid interchangeable tool pouch insert 300 in accordance with the present invention.

As shown, the rearward panel 204 may jut or protrude upward above the top surface of the forward panel 202. This portion of the rearward panel 204 comprises the upwardly protruding back 302. The sidewall 206 may also rise or have an inclined top surface to bridge the differential in height between the upwardly protruding back 302 and the forward panel 202.

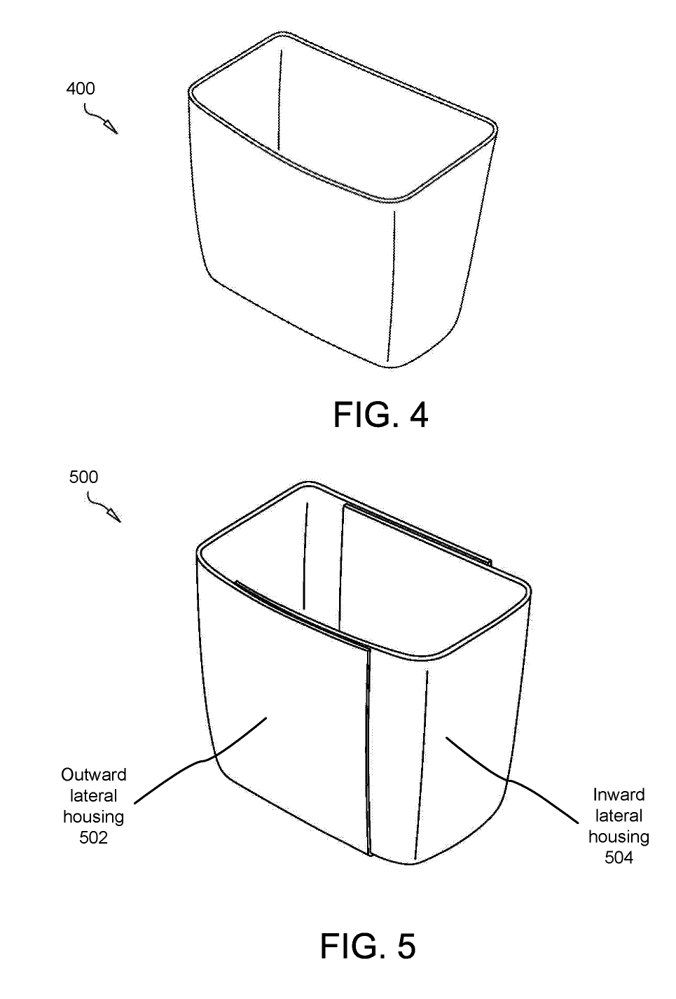

FIG. 4 is a forward-side perspective view of a rigid interchangeable tool pouch insert 400 in accordance with the present invention.

The insert 400 as shown is not adjustable in width.

FIG. 5 is a forward-side perspective view of a rigid interchangeable, adjustable tool pouch insert 500 in accordance with the present invention.

The insert 500 as shown is adjustable in width. In the shown embodiment, the insert 500 comprises an outward lateral housing 502 and an inward lateral housing 504. The outward lateral housing slips, slides or is slideably affixed or engaged with the inward lateral housing 504.

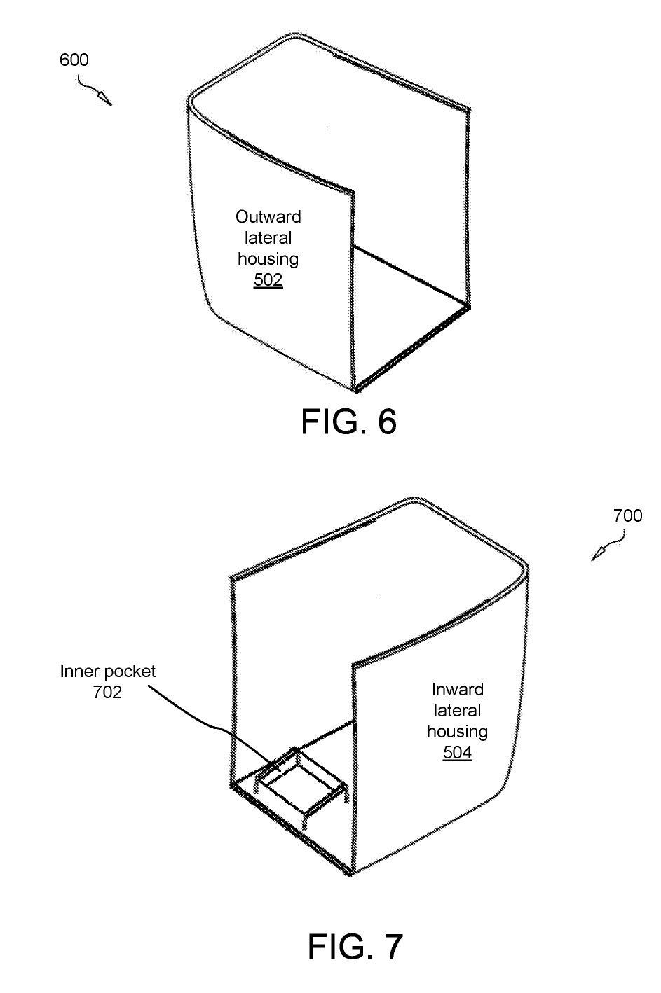

FIG. 6 is a forward-side perspective view of the outward lateral housing of a rigid interchangeable, adjustable tool pouch insert in accordance with the present invention.

The outward lateral housing 502 comprises an open top surface and an open lateral or side, and consists of only one sidewall 206.

FIG. 7 is a forward-side perspective view of the inward lateral housing of a rigid interchangeable, adjustable tool pouch insert in accordance with the present invention.

The lower top surface of the base 202 may comprise, in place of texture 254, upwardly protruding walls forming an inner pocket 702 for preventing sliding of implements within the insert 700.

The present invention may be adapted for use in tool bags, back packs, fanny packs, or any other portable container. The present invention may also be manufactured and used with an incidental tool bag or container, or may be manufactured as part of the tool bag or container.

The functions of the systems shown in the present invention correspond generally to other methods and apparati outlined in the present invention, and further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A rigid tool pouch liner, the tool pouch liner comprising:
a rearward panel having a planar interior surface and a planar exterior surface;
two sidewalls affixed to the rearward panel, the sidewalls disposed laterally to the rearward panel;
a forward panel affixed to the sidewalls, the forward panel having a planar interior surface and a planar exterior surface;
a base disposed beneath the sidewalls, the rearward panel, and the forward panel, the base affixed to the sidewalls, the rearward panel, and the forward panel;
an upwardly protruding back affixed to the rearward panel and the sidewalls, the upwardly protruding panel rising more than 10 mm above the forward panel;
wherein the rigid pouch liner forms a cubic housing with an open top end.

2. The rigid tool pouch liner of claim 1, wherein the rigid pouch liner is formed as a single integrated piece.

3. The rigid tool pouch liner of claim 1, wherein the tool pouch liner is adhered to a pouch of a tool bag using adhesive.

4. The rigid tool pouch liner of claim 1, wherein the base comprises thicker polymeric material than the forward panel, rearward panel, or sidewalls.

5. An adjustable-width pouch liner, the tool pouch liner comprising:
an outward housing comprising:
a rearward panel having a planar interior surface and a planar exterior surface;
a sidewalls affixed to the rearward panel, the sidewall disposed laterally to the rearward panel;
a forward panel affixed to the sidewall, the forward panel having a planar interior surface and a planar exterior surface;
a base disposed beneath the sidewall, the rearward panel, and the forward panel, the base affixed to the sidewalls, the rearward panel, and the forward panel;
wherein the outward housing forms a cubic housing with an open top end and an open lateral end, the outward housing for receiving slidably an inward housing;
an inward housing comprising:
a rearward panel having a planar interior surface and a planar exterior surface;
a sidewalls affixed to the rearward panel, the sidewall disposed laterally to the rearward panel;
a forward panel affixed to the sidewall, the forward panel having a planar interior surface and a planar exterior surface;
a base disposed beneath the sidewall, the rearward panel, and the forward panel, the base affixed to the sidewalls, the rearward panel, and the forward panel;
wherein the inward housing forms a cubic housing with an open top end and an open lateral end, the inward housing for partially inserting slidably into the outward ward housing.

6. A rigid pouch liner, the tool pouch liner comprising:
a polymeric rearward panel having a planar interior surface and a planar exterior surface;
two polymeric sidewalls affixed to the rearward panel, the sidewalls disposed laterally to the rearward panel;
a polymeric forward panel affixed to the sidewalls, the forward panel having a planar interior surface and a planer exterior surface;
a metal base disposed beneath the sidewalls, the rearward panel, and the forward panel, the base affixed to the sidewalls, the rearward panel, and the forward panel;
wherein the rigid pouch liner forms a cubic housing with an open top end.

7. The rigid tool pouch liner of claim 6, wherein the base comprises thicker polymeric material than the forward panel, rearward panel, or sidewalls.

8. The rigid tool pouch liner of claim 6, wherein the rigid pouch liner is formed as part of a larger tool bag.
